(19) United States
(12) Patent Application Publication
(10) Pub. No.: US 2008/0218437 A1
(43) Pub. Date: Sep. 11, 2008

(54) COMPUTER AND DISPLAY DEVICE

(75) Inventor: Yuuichi Shimoi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 12/044,609

(22) Filed: Mar. 7, 2008

(30) Foreign Application Priority Data
Mar. 8, 2007 (JP) 2007-058375

(51) Int. Cl. G09G 3/00

(52) U.S. Cl. 345/30

(57) ABSTRACT

An electronic paper display device, which retains a display state even when power is off, is installed outside a server main body. A display control unit provided as software in the server main body displays the information, which indicates a substance of the abnormality detected in the server main body, for example, an error code indicating the substance of the abnormality, in the electronic paper display device. Even when power is turned off after the error code is displayed in the electronic paper display device due to failure of power or a cooling fan, the electronic paper display device maintains display of the error code even after the power-off by memory property of electronic paper.

This application is a priority based on prior application No. JP 2007-08375, filed Mar. 8, 2007, in Japan.

### BACKGROUND OF THE INVENTION

1. Field of the Invention

The present invention relates to a computer and a display device which display information necessary for maintenance of abnormality, and the like in the display device installed in a computer main body and, particularly, relates to a computer and a display device which display the information by using electronic paper as a display panel.

2. Description of the Related Arts

Conventionally, in a computer such as a personal computer or a server, when the computer malfunctions or a trouble occurs in software, the failure location can be normally displayed by using dedicated application software in the computer. On the other hand, when a cooling fan, power supply, or the like malfunctions, the power is immediately turned off since runaway of a CPU may occur due to heating or power malfunction. However, when the power is turned off because of failure of, for example, the cooling fan or power supply, the failure location cannot be displayed by the computer itself; therefore, following methods are conventionally used.

(1) A method in which a system board or the interior of a chassis is checked by visual observation.
(2) A method in which application software for monitoring examination capable of specifying the failure location is used.
(3) A method in which the value of a CPU register displayed in a screen is checked in the case in which a blue screen is shown and stopped in Windows (R).
(4) A method in which a simple failure location or error information is displayed and checked in a display unit by a sub-device even when a computer main body malfunctions since the sub-device having a small liquid-crystal display unit is provided in a processor for monitoring which operates independently from a main system board or a chassis in the computer such as a server.

However, when it is the failure by which power is turned off because of failure of the cooling fan, power supply, or the like, such conventional methods of checking failure locations have following problems. First of all, in the check by visual observation, specifying a fundamental cause is difficult in some cases even if a failure location can be estimated. The application for monitoring examination and the method of checking the value of the CPU register displayed in a screen have a problem that carrying out examination while malfunction remains upon failure is difficult since an OS has to be activated and application software has to be executed for specifying the failure location. Furthermore, the method of checking failure of the computer itself by the sub-device has a problem that, when power is turned off because of failure, the sub-device itself cannot be activated, and the failure cannot be checked.

### SUMMARY OF THE INVENTION

According to the present invention to provide a computer and display device which save and display an abnormality substance in a non-volatile manner so that a failure location or a failure cause can be quickly and appropriately understood even if power is turned off because of the abnormality.

(Computer)

The present invention provides a computer, and the computer of the present invention includes:

a computer main body which processes information;

a display device which is installed outside the computer main body and retains a display state even when power is off; and

a display control unit which is provided in the computer main body and displays information, which is detected in the computer main body, in the display device.

The display device has an electronic paper panel.

The display control unit displays the information, which is detected in the computer main body and necessary for maintenance, in the display device.

The display control unit displays the information, which indicates a substance of abnormality detected in the computer main body, in the display device.

The display control unit displays an error code, which indicates a substance of abnormality detected in the computer main body, in the display device.

The display control unit selects and set the information to be displayed in the display device in advance among information detected in the computer.

The display control unit displays information, which is input to the computer main body by a registering operation of a user, in the display device.

(Display Device)

The present invention provides a display device, and the display device of the present invention includes:

a display device main body which is installed outside or in the vicinity of a computer and retains a display state even when power is off; and

an interface cable which is connector-connected to the computer and supplies power and a display information signal to the display device main body.

The display device main body has an electronic paper panel, a driver circuit, and an interface circuit.

The display device main body displays information which is detected in the computer and necessary for maintenance.

The display device main body displays information which indicates a substance of abnormality detected in the computer main body.

The display device main body displays an error code which indicates a substance of abnormality detected in the computer.

The display device main body displays information which is selected and set in advance among information detected in the computer.

The display device main body displays information which is input to the computer by a registering operation of a user.

According to the computer of the present invention, the display device having the electronic paper panel can change the display substance by controlling a drive voltage, has the memory property of keeping display of the substance which is displayed immediately before even after power is turned off, can retain display of the abnormality substance before power-off even in the case in which the power of the computer is quickly turned off after failure relating to power supply or a cooling fan is detected and displayed, enables precise understanding of the failure location or failure substance with respect to the failure that involves power-off by seeing display of the abnormality substance, and significantly improves maintenance performance. By using the error codes determined in a manual in display of the abnormality substance, the electronic paper panel can be downsized, and the cost of the display unit can be reduced. In another mode of the present invention, a display device using an electronic paper panel which can be used by connecting itself to a computer by an interface cable such as a USB cable which can supply power is provided; therefore, even in an existing computer, when the display device of the present invention is cable-connected, the abnormality substance can be saved and displayed for the failure that involves power-off, the failure location and failure substance can be precisely and readily understood, and maintenance performance can be similarly significantly improved. The above and other objects, features, and advantages of the present invention will become more apparent from the following detailed description with reference to the drawings.

### BRIEF DESCRIPTION OF THE DRAWINGS

FIG. 1 is an explanatory diagram showing an embodiment of a server to which the present invention is applied;

FIG. 2 is an explanatory diagram showing unit arrangement of the interior of a server main body in a present embodiment;

FIGS. 3A and 3B are explanatory diagrams showing a hardware configuration of a computer constituting the server in the present embodiment together with allocation of software;

FIG. 4 is an explanatory diagram showing a structure of an electronic paper panel used in the present embodiment;

FIG. 5 is a block diagram showing a functional configuration for display control in the present embodiment;

FIG. 6 is an explanatory diagram showing the display management table provided in the display control unit of FIG. 5;

FIG. 7 is a flow chart showing a display information select process of registering display flags in the display management table of FIG. 6;

FIGS. 8A and 8B are flow charts showing a display control process with respect to an electronic paper display device according to the present embodiment;

FIG. 9 is an explanatory drawing showing another embodiment of the electronic paper display device according to the present invention used by connecting it to a computer by a cable; and

FIG. 10 is an explanatory drawing showing the state in which the electronic paper display device of FIG. 9 is attached to the server.

### DETAILED DESCRIPTION OF THE PREFERRED EMBODIMENTS

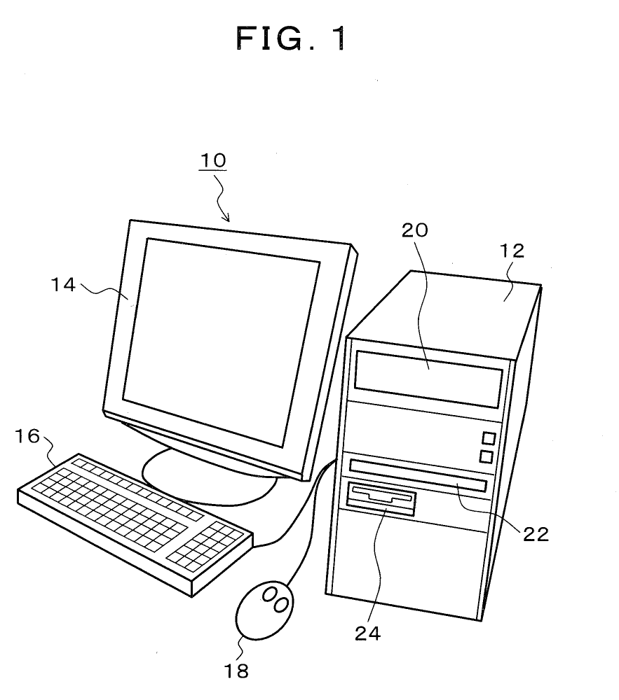

FIG. 1 is an explanatory diagram showing an embodiment of a server as a computer to which the present invention is applied. In FIG. 1, the server 10 comprises a server main body 12, a display 14, a keyboard 16, and a mouse 18. In a front part of the server main body 12, a CD-ROM drive 22 and a FD drive 24 are provided. In an upper part of the front surface of the server main body, an electronic paper display device 20 according to the present embodiment is disposed.

When display control software installed in the server main body 12 is executed, information indicating the substance of abnormality detected in the server main body 12, for example, an error code is displayed on the electronic paper display device 20. The electronic paper display device 20 uses an electronic paper panel as a display panel. A voltage has to be applied to the electronic paper panel when the electronic paper panel is to be displayed and driven; however, after display, the panel has memory property that retains the display state even after the voltage is turned off. Therefore, even when the power is turned off after, for example, power failure or failure of a cooling fan, and the like is detected in the server main body 12 and an error code is displayed in the electronic paper display device 20, the error code indicating failure of the power supply or cooling fan is retained without modification in the electronic paper display device 20 even in the state after the power supply is turned off.

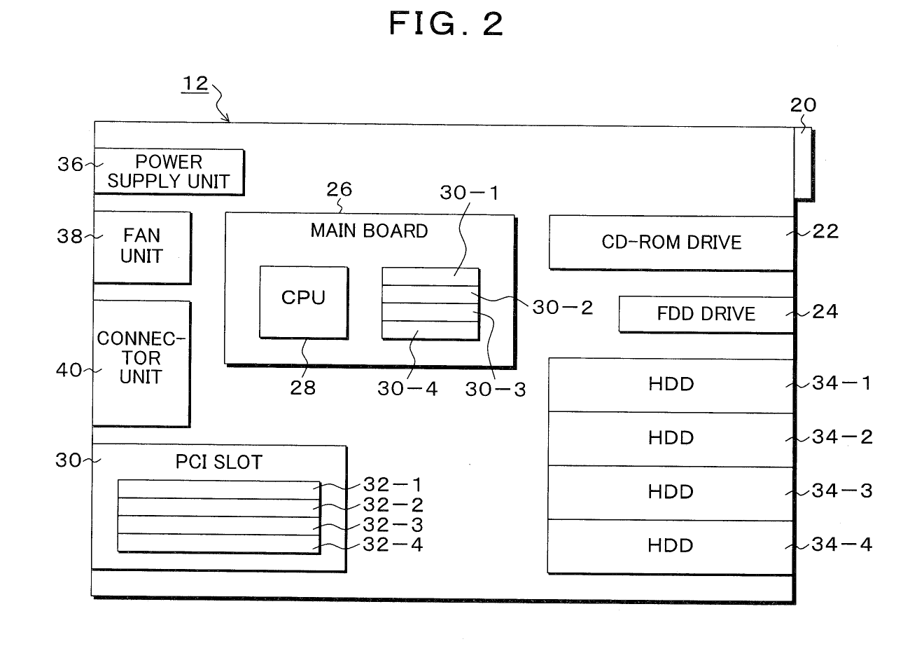

FIG. 2 is an explanatory diagram showing a unit arrangement in the server main body 12 in the present embodiment. In FIG. 2, a main board 26 is provided in the server main body 12, and a CPU 28 and memories 30-1 to 30-4 are mounted on the main board 26. In addition, a PCI slot 30 is provided in the server main body 12, and PCI boards 32-1 to 32-4 are attached to the PCI slot 30. In addition, in the server main body 12, as storage devices, the CD-ROM drive 22, the FD drive 24, and hard disk drives (HDDs) 34-1 to 34-4 are disposed. Furthermore, a power supply unit 36, a fan unit 38, and a connector unit 40 are provided in the server main body 12.

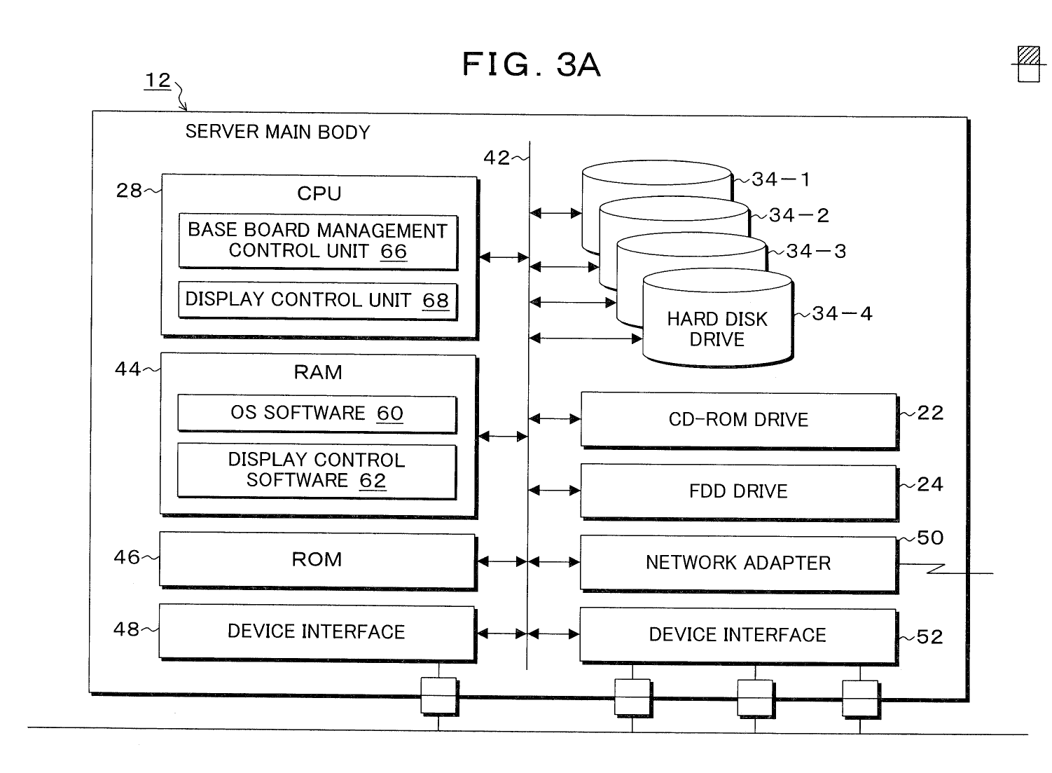

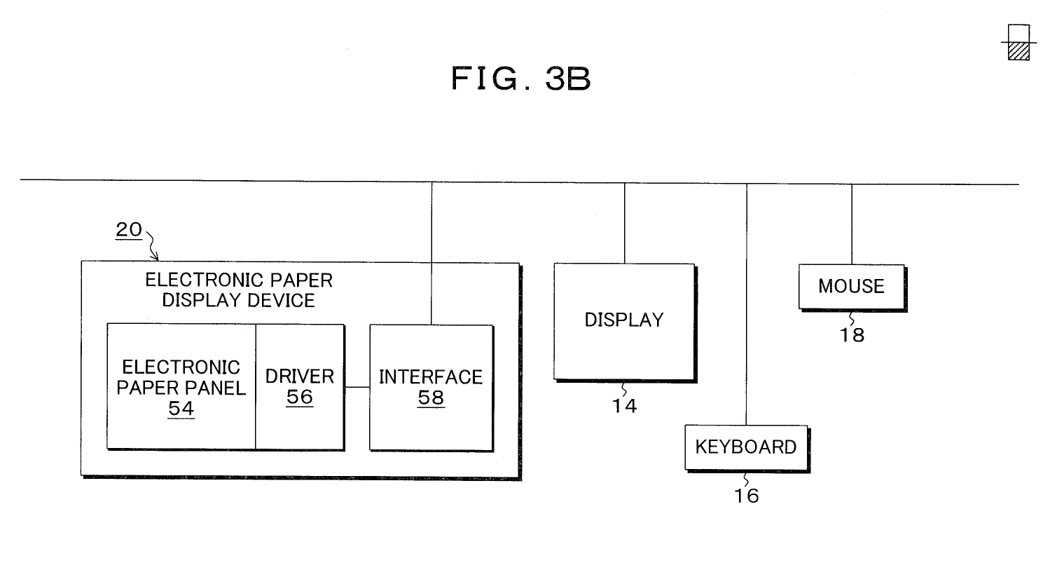

FIGS. 3A and 3B are explanatory diagrams showing, together with software arrangement, a hardware configuration of a computer constituting the server in the present embodiment. In FIGS. 3A and 3B, a CPU 28 is provided in the server main body 12; and, to a bus 42 of the CPU 28, a RAM 44, a ROM 46, the hard disk drives 34-1 to 34-4, the CD-ROM drive 22, the FD drive 24, a network adapter 50, and a device interface 52 connecting the display 14, the keyboard 16, and the mouse 18 are connected. The electronic paper display device 20, which is newly provided in the present embodiment, is connected to the bus 42 by a device interface 48. In the hard disk drive 34-1 to 34-4-side, OS software and display control software used in the present embodiment is installed. When the server main body 12 is activated, a boot code is executed by BIOS of the ROM 46, thereby reading and arranging the OS software 60 from the hardware disk drive-side to the RAM 44. When the OS software 60 is executed by the CPU 28, the display control software 62 is read and arranged from the hard disk drive-side to the ROM 46. When the OS software 60 of the RAM 44 is executed by the CPU 28, the function as a base board management control unit 66 shown in the CPU 28 is realized. When the display control software 62 of the RAM 44 is executed by the CPU 28, the function of a display control unit 68 shown in the CPU 28 for performing display control of the electronic paper display device 20 is realized.

The electronic paper display device 20 has an electronic paper panel 54, a driver 56, and an interface 58. For example, I2C (R) buses are used as the device interface 48 of the server main body 12 and the interface 58 of the electronic paper display device 20-side. The I2C (R) bus is a two-wire-type low-speed serial data transmission bus proposed by Philips and is usually used for sweeping signals between integrated circuits on a same circuit board; and, in the present embodiment, the I2C (R) bus is used for display control with respect to the electronic paper display device 20. As a matter of course, an arbitrary interface bus other than the I2C bus can be used.

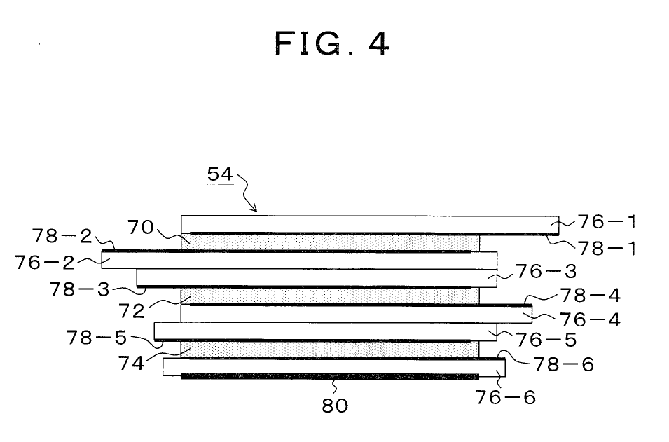

FIG. 4 is an explanatory diagram showing a structure of the electronic paper panel provided in the electronic paper display device 20 of the present embodiment. In the electronic paper panel 54 of the present embodiment, a liquid crystal layer 70 for blue, a liquid crystal layer 72 for green, and a liquid crystal layer 74 for red are laminated and disposed, and transparent films 76-1 to 76-6 and transparent electrodes 78-1 to 78-6 are disposed on the upper and lower sides thereof, respectively. In addition, a light absorption layer 80 for displaying black is provided at an undermost part. Each of the liquid crystal layer 70 for blue, the liquid crystal layer 72 for green, and the liquid crystal layer 74 for red uses choresteric liquid crystals. The choresteric liquid crystals have a characteristic of reflecting merely particular wavelengths (light), and each of them reflects a determined wavelength of red, green, or blue, thereby implementing full-color display. Herein, when all the colors are reflected, white is seen because of light's three primary colors; and, when all the colors are not reflected, black of the light absorption layer 80 which is the lowest layer is seen. The choresteric liquid crystals provided in the liquid crystal layer 70 for blue, the liquid crystal layer 72 for green, and the liquid crystal layer 74 for red have memory property and can be caused to be in a planar state in which light of particular wavelengths is reflected, a focal conic state in which light is transmitted, or an intermediate state thereof by adjusting the electric field intensity (voltage) applied to the liquid crystals. Once the planar state, the focal conic state, or the intermediate state is implemented, the memory property that the state is stably maintained without applying a voltage can be ensured thereafter. In the plane state, liquid crystal molecules sequentially rotate in the substrate thickness direction and form a helical structure, the helical axis of the helical structure is approximately perpendicular to the substrate surface, and light of a predetermined wavelength corresponding to the helical pitch of the liquid crystal molecules is selectively reflected. Meanwhile, liquid crystal molecules in the focal conic state sequentially helically rotate in the substrate liquid crystal in-plane direction and form a helical structure, and the helical axis of the helical structure is parallel to the substrate surface. In this state, selectivity of the reflected wavelengths in the liquid crystal layers is lost, and most incoming light is transmitted. In the intermediate state between the plane state and the focal conic state, the intensity of reflected light can be adjusted since the ratio of reflected light and transmitted light can be adjusted in accordance with the state. Specifically, in an initial state, the liquid crystal molecules of the layers are in the planar state in which the helical axis is approximately perpendicular to the substrate surface, which is the state in which light is reflected, and white is to be displayed by the three primary colors. In this state, when a low voltage is applied to a part through which light is desired to be transmitted, the focal conic state in which the helical axis is approximately parallel to the substrate surface is attained, and this state is maintained even when the voltage is turned off. When the state is to be changed from the focal conic state, in which light is transmitted, to the plane state, in which light is reflected, the helical axis can be caused to be approximately perpendicular to the substrate surface by applying a high voltage.

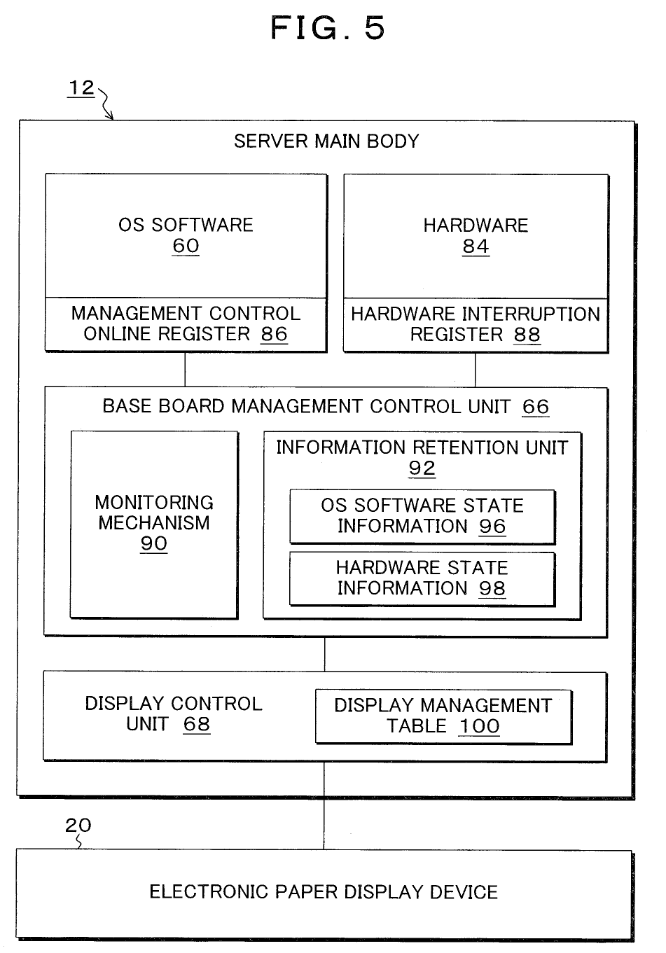

FIG. 5 is a block diagram showing a functional configuration for display control of the server main body in the present embodiment. In FIG. 5, in the server main body 12, hardware 84 and the OS software 60 realized by components such as a CPU memory and an IO device are provided. In addition, in the base board management control unit 66, a monitoring mechanism 90 and an information retention unit 92 are provided. The monitoring mechanism 90 receives OS software state information, which is a hardware control order generated during operation of the OS software 60, from a management control online register 86 through an online notification and saves changed OS software state information as OS software state information 96 in the information retention unit 92. When the monitoring mechanism 90 receives hardware state information including an error from the hardware 84 via a hardware interruption register 88, the monitoring mechanism saves the received hardware state information as hardware state information 98 in the information retention unit 92. The display control unit 68 references the hardware state information 98 saved in the information retention unit 92 by the monitoring mechanism 90 of the base board management control unit 66, retrieves an abnormality substance included in the hardware state information 98, transmits an error code indicating the abnormality substance to the electronic paper display device 20, and causes the device to display it. In the display control unit 68, a display management table 100 is provided. In the display management table 100, display flags by which error codes to be displayed by the electronic paper display device 20 of the present embodiment by user setting are registered.

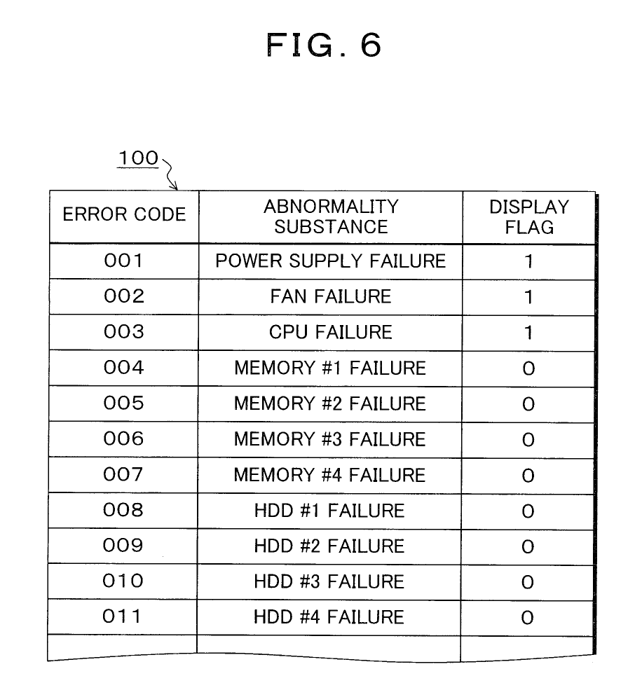

FIG. 6 is an explanatory diagram showing the display management table 100 provided in the display control unit 68 of FIG. 5. In FIG. 6, the display management table 100 comprises the error codes, the abnormality substances, and the display flags. The error codes correspond to the abnormality substances. As the abnormality substances, for example, various hardware failures such as power failure, fan failure, CPU failure, and HDD failure is set. With respect to such abnormality substances, the display control unit 68 can select an abnormality substance to be displayed in the electronic paper display device 20 based on a select operation by a user. In the case of FIG. 6, when the display flag is set to “1”, it can be select as a display object of the electronic paper display device 20. As the abnormality substances for the electronic paper display device 20 selected by setting the display flags of the display management table 100 as “1”, mainly, power supply failure, fan failure, and CPU failure by which the power supply of the server main body 12 is turned off by failure detection substances can be selected. By performing display select in this manner for the failure that involves power-off, the display contents of the error code can be caused to remain in the electronic paper display device 20 even in a power-off state. Furthermore, the display control unit 68 can also display the information input by a registering operation of a user in the electronic paper display device 20.

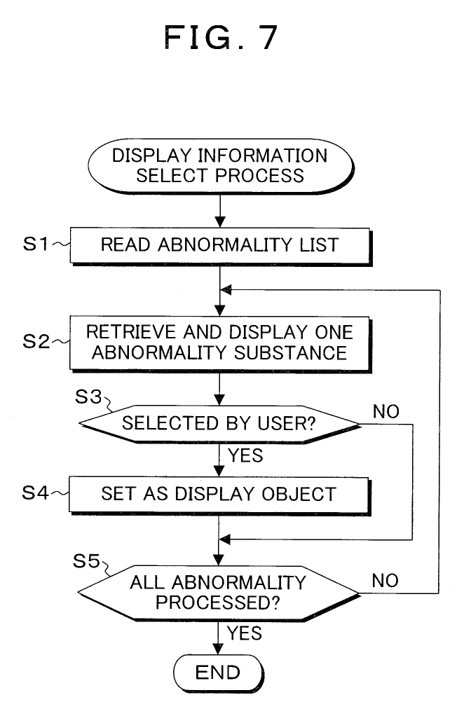

FIG. 7 is a flow chart showing a display select process of registering display flags in the display management table 100 of FIG. 6, which can be performed by using software serving as a dedicated tool for display information select. As a matter of course, this function as the tool for display select may be provided in the display control software 62 of the present embodiment. In FIG. 7, in the display information select process, the display management table 100 is read in step S1, one abnormality substance is retrieved and displayed in step S2, select by a user is waited for in step S3, and, when it is selected as a display object by the user, the display flag is set to “1” as a display object in step S4. Such process of steps S1 to S4 is repeated until all abnormalities are processed in step S5. As a matter of course, the process can be stopped at an intermediate stage when registering of necessary abnormality substances is finished.

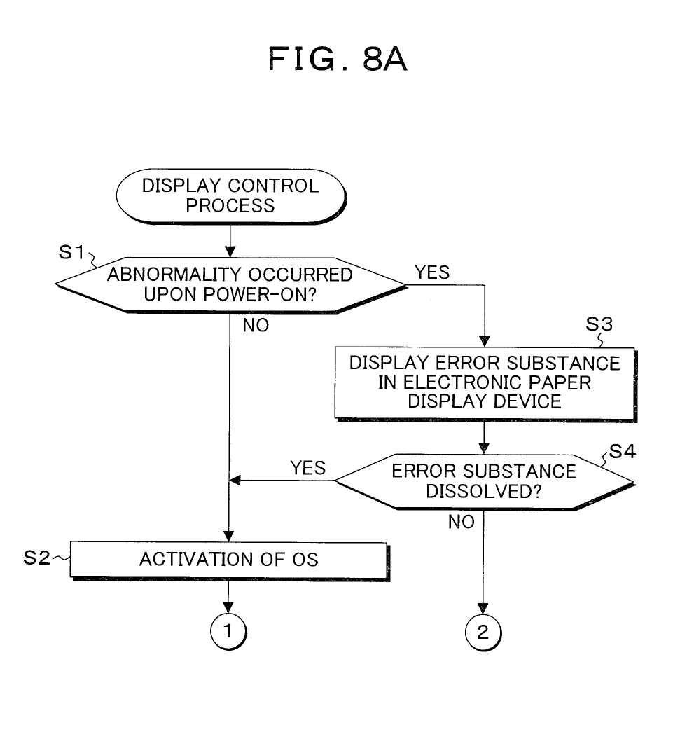

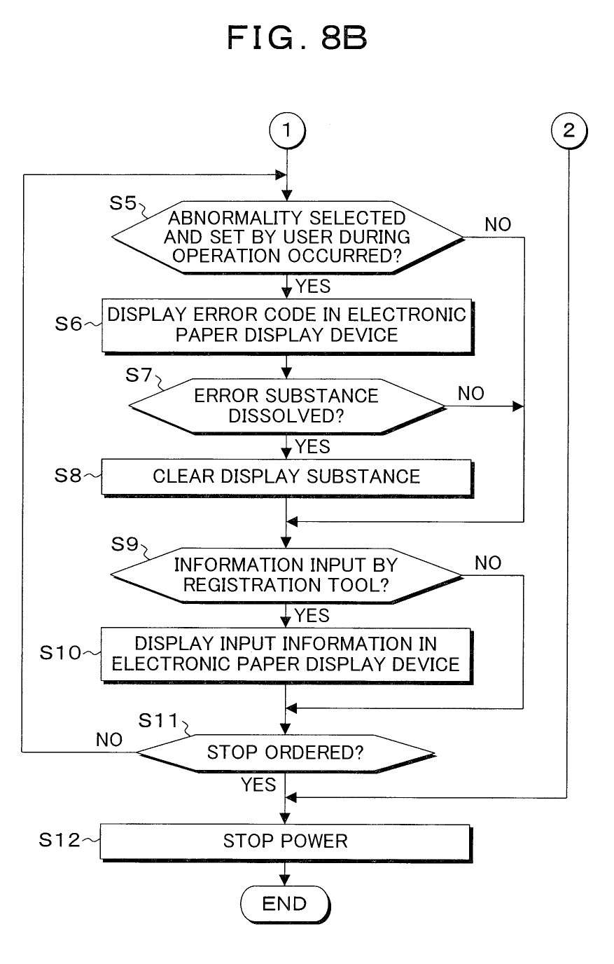

FIGS. 8A and 8B are flow charts showing a display control process with respect to the electronic paper display device 20 according to the present embodiment, which is a processing procedure of the display control unit 68 provided in the CPU 28 of FIGS. 3A and 3B. In FIGS. 8A and 8B, in the display control, first of all, whether abnormality has occurred or not upon power-on of the server main body 12 is determined in step S1. If there is no occurrence of abnormality upon power-on, the OS software is activated in step S2. Meanwhile, if abnormality occurs upon power-on, the process proceeds to step S3 in which the error substance, specifically, a corresponding error code is displayed in the electronic paper display device 20. Subsequently, the process proceeds to step S4 in which whether the error substance has been dissolved or not is checked. If the error substance is dissolved, the process proceeds to step S2 in which the OS software is activated. If the error substance is not dissolved, the process proceeds to step S12 in which the power is turned off. The power supply to the electronic paper display device 20 is also stopped along with this power-off; however, the error substance displayed in step S3 can be kept being displayed without modification by virtue of the memory property of the electronic paper panel even when the power is off. After the OS software is activated in step S2, whether the abnormality for which the display flag “1,” is set in the display management table 100 of FIG. 6 selected and set by the user during operation has occurred or not is checked in step S5. If the selected abnormality has occurred, the process proceeds to step S6 in which an error code is displayed in the electronic paper display device 20. Subsequently, if the error substance has been dissolved or not is determined in step S7. If it has been dissolved, the display substance is cleared in step S8; or, if it has not been dissolved, step S8 is skipped, and the error substance is retained. Subsequently, whether there is information input performed by the user by using the dedicated registration tool is checked in step S9. If there is the information input by the user registration tool, the process proceeds to step S10 in which the information recorded by the user is displayed in the electronic paper display device 20. The information input by the user by using the registration tool is, for example, information necessary for maintenance of the server, particularly, it is desirably the information desired to be kept being displayed even when power is off due to failure or the like of the server, for example, a contact phone number, of the like of a maintainer is desired to be input and displayed. Subsequently, presence of a stop order is checked in step S11. If there is the stop order, the power is turned off and the process is terminated in step S12.

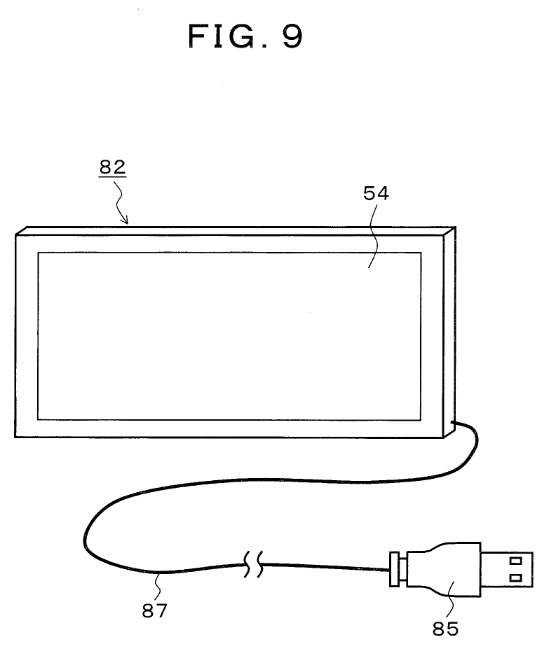

FIG. 9 is an explanatory drawing showing another embodiment of the electronic paper display device in the present embodiment used by connecting to a computer by a cable. In the embodiment of FIG. 1, the electronic paper display device 20 is assembled in the server main body 12 in a manufacturing stage, and the electronic paper display device 20 of this embodiment cannot be used for an existing server. Therefore, in the embodiment of FIG. 9, a portable-type electronic paper display device 82 which can be used by externally connecting itself to a computer such as a server is provided. In FIG. 9, the portable-type electronic paper display device 82 has the electronic paper panel 54, and a USB cable 87 provided with a USB connector 85 is lead out therefrom in the outside. In a USB interface using the USB cable 87, when the USB connector 85 is connected to the server main body-side, display control signals and power supply can be fed to the portable-type electronic paper display device 82 by a power line and a signal line in the cable.

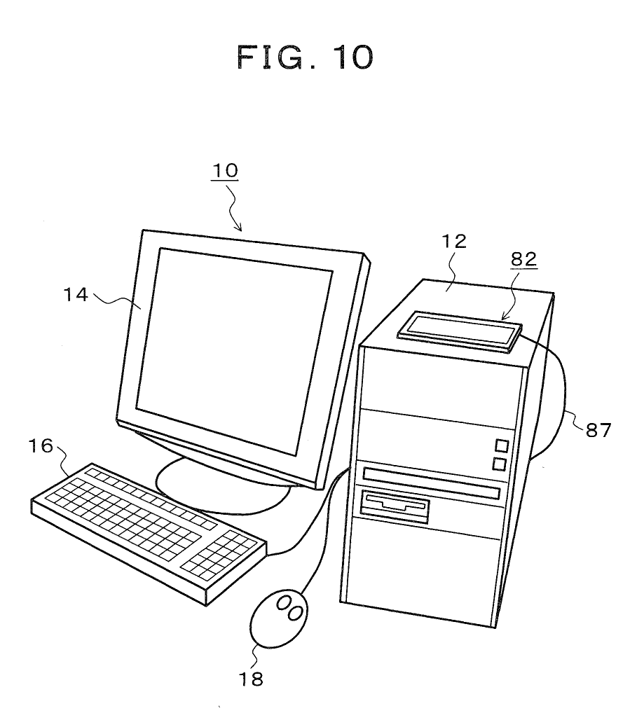

FIG. 10 is an explanatory drawing showing the state in which the portable-type electronic paper display device of FIG. 9 is attached to the server. In FIG. 10, the USB connector 85 of the portable-type electronic paper display device 82 shown in FIG. 9 is connected to a USB connector on the rear surface of the server main body 12, and the portable-type electronic paper display device 82 can be subjected to use by, for example, disposing the device by attaching the device on an upper part of the server main body 12 by, for example, a double-sided tape. In the server main body 12, as well as the embodiment of FIG. 1, the function of the display control unit 68 realized by execution of the display control software 62 shown in FIGS. 3A, 3B, and FIG. 5 is realized. When failure of the power supply or cooling fan is detected in the server main body, an error code indicating the abnormality is displayed in the portable-type electronic paper display device 82, and the error code is saved by the memory property of the electronic paper panel 54 even when the power of the server main body 12 is turned off thereafter. Thereafter, when the server 10 is subjected to maintenance check, the failure location can be appropriately understood by seeing the error code, and an appropriate response can be taken. Note that, although a server has been taken as an example of the computer in the above described embodiments, other than that, the electronic paper display devices of the present embodiments can be applied to a personal computer or an arbitrary information processing device without modification. In the portable-type electronic paper display device 82 of FIG. 9, the case in which it is connected to the server main body 12 by the USB cable which supplies power at the same time as signals for using it has been taken as an example; however, other than this, a small-power wireless interface used in, for example, a wireless tag may be used. When the small-power wireless interface is used, a battery has to be incorporated in the portable-type electronic paper display device 82-side. The present invention includes arbitrary modifications that do not impair the objects and advantages thereof, and the present invention is not limited by the numerical values shown in the above described embodiments.

What is claimed is:

1. A computer comprises:
a computer main body which processes information;
a display device which is installed outside the computer main body and retains a display state even when power is off; and
a display control unit which is provided in the computer main body and displays information, which is detected in the computer main body, in the display device.

2. The computer according to claim 1, wherein the display device has an electronic paper panel.

3. The computer according to claim 1, wherein the display control unit displays the information, which is detected in the computer main body and necessary for maintenance, in the display device.

4. The computer according to claim 1, wherein the display control unit displays the information, which indicates a substance of abnormality detected in the computer main body, in the display device.

5. The computer according to claim 1, wherein the display control unit displays an error code, which indicates a substance of abnormality detected in the computer main body, in the display device.

6. The computer according to claim 1, wherein the display control unit selects and set the information to be displayed in the display device in advance among information detected in the computer.

7. The computer according to claim 1, wherein the display control unit displays information, which is input to the computer main body by a registering operation of a user, in the display device.

8. A display device comprises:
a display device main body which is installed outside or in the vicinity of a computer and retains a display state even when power is off; and
an interface cable which is connector-connected to the computer and supplies power and a display information signal to the display device main body.

9. The display device according to claim 8, wherein the display device main body has an electronic paper panel, a driver circuit, and an interface circuit.

10. The display device according to claim 8, wherein the display device main body displays information which is detected in the computer and necessary for maintenance.

11. The display device according to claim 8, wherein the display device main body displays information which indicates a substance of abnormality detected in the computer.

12. The display device according to claim 8, wherein the display device main body displays an error code which indicates a substance of abnormality detected in the computer.

13. The display device according to claim 8, wherein the display device main body displays information which is selected and set in advance among information detected in the computer.

14. The display device according to claim 8, wherein the display device main body displays information, which is input to the computer by a registering operation of a user.
